(19) United States
(12) Patent Application Publication
(10) Pub. No.: US 2024/0056339 A1
(43) Pub. Date: Feb. 15, 2024

(54) SRS ENHANCEMENT FOR INTERFERENCE RANDOMIZATION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/352,166

(22) Filed: Jul. 13, 2023

Related U.S. Application Data
(60) Provisional application No. 63/393,120, filed on Jul. 28, 2022.
(60) Provisional application No. 63/393,124, filed on Jul. 28, 2022.

(51) Int. Cl. H04L 27/26; H04L 5/00

(52) U.S. Cl. CPC H04L 27/2613; H04L 5/0048; H04L 27/2607

(57) ABSTRACT

Apparatuses and methods for SRS enhancement for interference randomization in wireless networks. A method performed by a user equipment (UE) includes receiving a configuration about a sounding reference signal (SRS) resource. The configuration includes information about a cyclic shift offsetϵ{0,1, . . . , n_{SRS}^{CS,max}−1} and a transmission-comb offsetϵ{0,1, . . . , K_{TC}−1}. n_{SRS}^{CS,max} is a maximum number of cyclic shifts and K_{TC} is a transmission comb number. The SRS resource is associated with a plurality of antenna ports. The method further includes determining, based on a first pseudo-random sequence, the cyclic shift offset for each of the plurality of antenna ports; determining, based on a second pseudo-random sequence, the transmission-comb offset for each of the plurality of antenna ports; and transmitting, based on the cyclic shift offset and the transmission-comb offset, the SRS resource.

### CROSS-REFERENCE TO RELATED APPLICATION AND CLAIM OF PRIORITY

This application claims priority under 35 U.S.C. § 119(e) to U.S. Provisional Patent Application No. 63/393,120 filed on Jul. 28, 2022, and U.S. Provisional Patent Application No. 63/393,124 filed on Jul. 28, 2022. The above-identified provisional patent applications are hereby incorporated by reference in their entirety.

### TECHNICAL FIELD

The present disclosure relates generally to wireless communication systems and, more specifically, to electronic devices and methods for sounding reference signal (SRS) enhancement for interference randomization in wireless networks.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for SRS enhancement for interference randomization.

In one embodiment, a user equipment (UE) is provided. The UE includes a transceiver configured to receive a configuration about a sounding reference signal (SRS) resource. The configuration includes information about a cyclic shift offsetϵ{0,1, . . . , n_{SRS}^{CS,max}−1} and a transmission-comb offsetϵ{0,1, . . . , K_{TC}−1}. n_{SRS}^{CS,max} is a maximum number of cyclic shifts and K_{TC} is a transmission comb number. The SRS resource is associated with a plurality of antenna ports. The UE further includes a processor operably coupled to the transceiver. The processor is configured to determine, based on a first pseudo-random sequence, the cyclic shift offset for each of the plurality of antenna ports and determine, based on a second pseudo-random sequence, the transmission-comb offset for each of the plurality of antenna ports. The transceiver is further configured to transmit, based on the cyclic shift offset and the transmission-comb offset, the SRS resource.

In another embodiment, a base station (BS) is provided. The BS includes a transceiver configured to transmit a configuration about a sounding reference signal (SRS) resource and receive the SRS resource. The configuration includes information about a cyclic shift offsetϵ{0,1, . . . , n_{SRS}^{CS,max}−1} and a transmission-comb offsetϵ{0,1, . . . , K_{TC}−1}. n_{SRS}^{CS,max} is a maximum number of cyclic shifts and K_{TC} is a transmission comb number. The SRS resource is associated with a plurality of antenna ports. A first pseudo-random sequence indicates the cyclic shift offset for each of the plurality of antenna ports. A second pseudo-random sequence indicates the transmission-comb offset for each of the plurality of antenna ports.

In yet another embodiment, a method performed by a UE is provided. The method includes receiving a configuration about a SRS resource. The configuration includes information about a cyclic shift offsetϵ{0,1, . . . , n_{SRS}^{CS,max}−1} and a transmission-comb offsetϵ{0,1, . . . , K_{TC}−1}. n_{SRS}^{CS,max} is a maximum number of cyclic shifts and K_{TC} is a transmission comb number. The SRS resource is associated with a plurality of antenna ports. The method further includes determining, based on a first pseudo-random sequence, the cyclic shift offset for each of the plurality of antenna ports; determining, based on a second pseudo-random sequence, the transmission-comb offset for each of the plurality of antenna ports; and transmitting, based on the cyclic shift offset and the transmission-comb offset, the SRS resource.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure;

FIG. 5 illustrates an example of code-domain hopping using cyclic shift across time symbols according to embodiments of the present disclosure;

FIG. 6 illustrates an example of code-domain hopping using cyclic shift across time slots according to embodiments of the present disclosure;

FIG. 7 illustrates an example of frequency-domain hopping using transmission comb offset across time symbols according to embodiments of the present disclosure;

FIG. 8 illustrates an example of frequency-domain hopping using transmission comb offset across time slots according to embodiments of the present disclosure; and

FIG. 9 illustrates an example method performed by a UE in a wireless communication system according to embodiments of the present disclosure.

### DETAILED DESCRIPTION

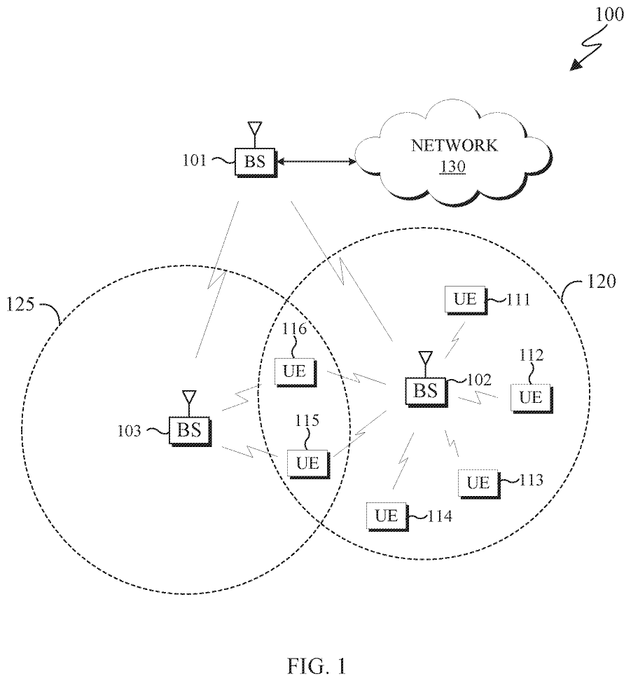

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.2.0, “E-UTRA, Multiplexing and Channel coding” (herein “REF 2”); 3GPP TS 36.213 v17.2.0, “E-UTRA, Physical Layer Procedures” (herein “REF 3”); 3GPP TS 36.321 v17.1.0, “E-UTRA, Medium Access Control (MAC) protocol specification” (herein “REF 4”); 3GPP TS 36.331 v17.1.0, “E-UTRA, Radio Resource Control (RRC) Protocol Specification” (herein “REF 5”); 3GPP TS 38.211 v17.2.0, “NR, Physical channels and modulation” (herein “REF 6”); 3GPP TS 38.212 v17.2.0, “NR, Multiplexing and Channel coding” (herein “REF 7”); 3GPP TS 38.213 v17.2.0, “NR, Physical Layer Procedures for Control” (herein “REF 8”); 3GPP TS 38.214 v17.2.0, “NR, Physical Layer Procedures for Data” (herein “REF 9”); 3GPP TS 38.215 v17.1.0, “NR, Physical Layer Measurements” (herein “REF 10”); 3GPP TS 38.321 v17.1.0, “NR, Medium Access Control (MAC) protocol specification” (herein “REF 11”); 3GPP TS 38.331 v17.1.0, “NR, Radio Resource Control (RRC) Protocol Specification” (herein “REF 12”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

One feature of Rel-18 MIMO items is to introduce coherent joint transmission (CJT) from multiple TRPs. In time division duplex (TDD), channel acquisition for downlink can be inferred by uplink channel state information through exploiting channel reciprocity. Acquiring uplink channel state information can be done by transmitting SRS from UE. In particular, it becomes to support more UEs in mTRP CJT scenarios compared to sTRP scenarios, which may result in inter-cell interference when receiving SRSs transmitted from many UEs at NW.

In Rel-18 MIMO WID, SRS enhancement has been adopted to provide further flexible configuration to manage inter-TRP interference in TDD C-JT scenarios, as shown in the following description.
4. Study, and if justified, specify enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, considering throughput-overhead trade-off
   SRS enhancement to manage inter-TRP cross-SRS interference targeting TDD CJT via SRS capacity enhancement and/or interference randomization, with the constraints that 1) without consuming additional resources for SRS; 2) reuse existing SRS comb structure; 3) without new SRS root sequences
   Note: the maximum number of CSI-RS ports per resource remains the same as in Rel-17, i.e., 32.

The present disclosure considers SRS enhancement to manage inter-TRP interference targeting TDD CJT.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for supporting SRS enhancement for interference randomization. In certain embodiments, one or more of the BSs 101-103 include circuitry, programing, or a combination thereof for supporting SRS enhancement for interference randomization.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

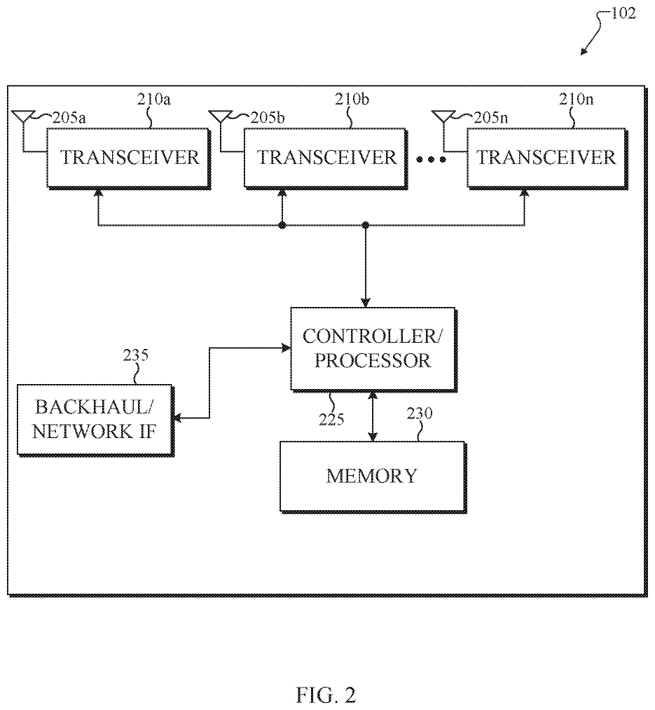

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNB s come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting SRS enhancement for interference randomization. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

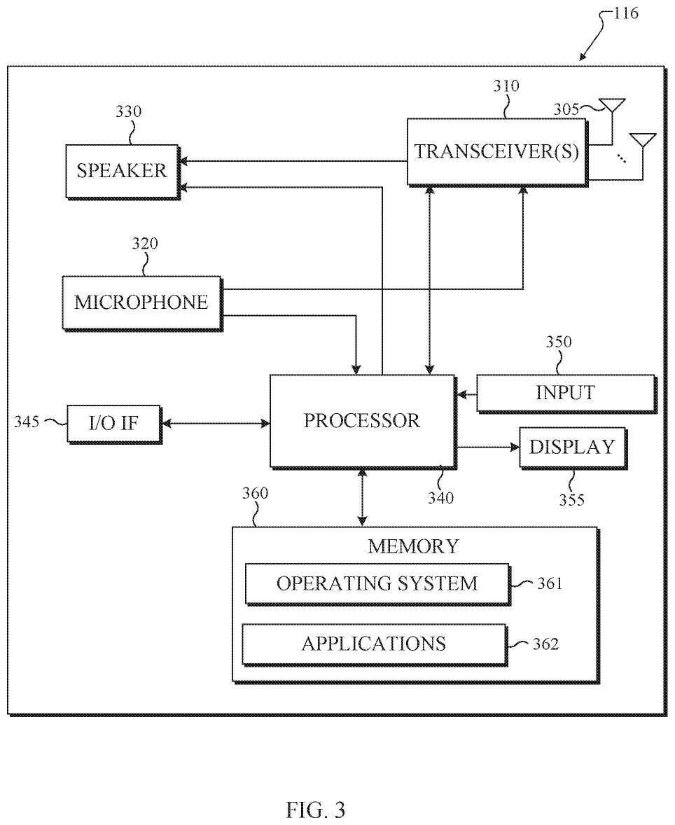

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for SRS enhancement for interference randomization. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

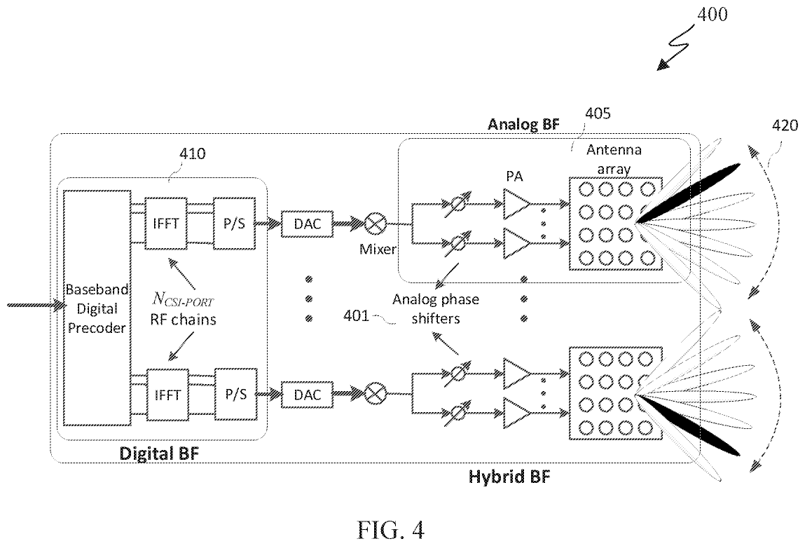

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of this disclosure to any particular implementation of the antenna blocks or arrays.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

Various embodiments of the present disclosure recognize that in the current SRS framework, it is supported that an SRS resource is only associated with a same set of cyclic shifts across time resources. Significant interference may occur when some UEs happen to be allocated with SRS resources having a same set of time/frequency/code resources (e.g., called collision), and it will keep interfering significantly unless it is reconfigured with another set of time/frequency/code resources. Further, various embodiments of the present disclosure recognize that in the current SRS framework, it is supported that an SRS resource is only associated with a same transmission comb offset. Significant interference may occur when some UEs happen to be allocated with SRS resources having a same set of time/frequency/code resources (e.g., collision), and it will keep interfering significantly unless it is reconfigured with another set of time/frequency/code resources.

Accordingly, various embodiments of the present disclosure provide mechanisms for enabling cyclic-shift hopping across times, for example, slots, symbols, etc., in order to avoid potential constant interference when SRS resources for some UEs happen to be the same. This cyclic-shift hopping method can provide several benefits, such as interference can be randomized across time as cyclic shifts can be different across time. Even if a collision happens for some UEs at a certain time, cyclic shift hopping allows interference to be relaxed/randomized at a different time.

Further, various embodiments of the present disclosure provide mechanisms for enabling transmission comb offset hopping across times, for example, slots, symbols, etc., in order to avoid potential constant interference when SRS resources for some UEs happen to be the same. This transmission comb hopping method can provide several benefits, such as interference can be alleviated across times as the transmission comb offset can be different across times. Even if a collision happens for some UEs at a certain time, transmission comb offset hopping allows interference to be alleviated/suppressed at a different time.

In TDD, SRS transmissions from UEs are a main source for CSI acquisition at the gNB as to both of UL and DL channels. SRS transmissions, however, can be more congested in a multi-TRP (mTRP) scenario wherein a gNB controlling mTRP capable of CJT can support more UEs (associated with a given cell ID) and need more frequent CSI acquisition. This can result in increasing the possibility of scheduling SRS resources for multiple UEs that are overlapping in given time-and-frequency resources. Therefore, potential interference across SRS transmissions from multiple UEs can be severe in congested mTRP scenarios, and thus an SRS enhancement could be needed to manage inter-TRP/cross-SRS interference targeting TDD CJT.

Under the three constraints described in Rel-18 WID, the following two directions can be considered to randomize or manage inter-TRP cross-SRS interference:
Enhanced frequency hopping pattern
Enhanced code-domain (e.g., cyclic shift, root sequence, comb offset) hopping.

In Rel-17 SRS enhancement, the supported number of symbol repetitions has been increased up to 14 for SRS coverage enhancement. This could be useful in TDD CJT scenarios wherein cell-edge UEs that usually need a larger number of symbol repetitions are targeted as CJT candidates. On the other hand, inter-SRS interference could be worse across such scheduled UEs due to that situations under limited time/frequency resources can further frequently happen. To reduce interference in such scenarios, code-domain hopping (e.g., cyclic shift, and sequence group/number) across time symbols/slots can be considered for interference randomization across scheduled UEs. Code-domain hopping across symbols in frequency hopping SRS transmission can also be considered.

An SRS resource is configured by the SRS-Resource IE or the SRS-PosResource IE and consists of
Nₐₚ^{SRS}ϵ{1,2,4} antenna ports

$${\{ {p}_{i} \}}_{i = 0}^{{N}_{ap}^{SRS} - 1} ,$$

where the number of antenna ports is given by the higher layer parameter nrofSRS-Ports if configured, otherwise Nₐₚ^{SRS}=1, and pᵢ=1000+i when the SRS resource is in a SRS resource set with higher-layer parameter usage in SRS-ResourceSet not set to ‘nonCodebook’, or determined according to [6, TS 38.214] when the SRS resource is in a SRS resource set with higher-layer parameter usage in SRS-ResourceSet set to ‘nonCodebook’
N_{symb}^{SRS}ϵ{1,2,4,8,10,12,14} consecutive OFDM symbols given by the field nrofSymbols contained in the higher layer parameter resourceMapping
l₀, the starting position in the time domain given by l₀=N_{symb}^{slot}−1−l_{offset} where the offset l_{offset} ϵ{0,1, . . . ,13} counts symbols backwards from the end of the slot and is given by the field startPosition contained in the higher layer parameter resourceMapping and l_{offset}≥N_{symb}^{SRS}−1
k₀, the frequency-domain starting position of the sounding reference signal

The sounding reference signal sequence for an SRS resource shall be generated according to

r^{(p}^{ᵢ}⁾(n,l′)=r_{u,v}^{(α}^{ₐ}^{,δ)}(n)

0≤n≤M_{sc,b}^{SRS}−1

l′ϵ{0,1, . . . ,N_{symb}^{SRS}−1}

where M_{sc,b}^{SRS} is given by clause 6.4.1.4.3 of [6], r_{u,v}^{(α,δ)}(n) is given by clause 5.2.2 of [6] with δ=log₂(K_{TC}) and the transmission comb number K_{TC}ϵ{2,4,8} is contained in the higher-layer parameter transmissionComb. The cyclic shift αᵢ for antenna port pᵢ is given as

$${α}_{i} = 2 π \frac{{n}_{SRS}^{cs , i}}{{n}_{SRS}^{cs , max}} {n}_{SRS}^{cs , i} = \{ \begin{matrix}\begin{matrix}( {n}_{SRS}^{cs} + \\ \frac{{n}_{SRS}^{cs , max} ⌊ ( {p}_{i} - 10 \; 00 ) / 2 ⌋}{{N}_{ap}^{SRS} / 2} )\end{matrix} mod {n}_{SRS}^{cs , max} & if {N}_{ap}^{SRS} = 4 and {n}_{SRS}^{cs , max} = 6 \\ ( \begin{matrix}{n}_{SRS}^{cs} + \\ \frac{{n}_{SRS}^{cs , max} ⌊ ( {p}_{i} - 1000 )}{{N}_{ap}^{SRS} / 2} mod {n}_{SRS}^{cs , max}\end{matrix} & otherwise\end{matrix} ,$$

$${n}_{SRS}^{cs , i} = \{ \begin{matrix}( {n}_{SRS}^{cs} + \frac{{n}_{SRS}^{cs , max} ⌊ ( {p}_{i} - 10 \; 00 ) / 2 ⌋}{{N}_{ap}^{SRS} / 2} ) mod {n}_{SRS}^{cs , max} & if {N}_{ap}^{SRS} = 4 and {n}_{SRS}^{cs , max} = 6 \\ ( {n}_{SRS}^{cs} + \frac{{n}_{SRS}^{cs , max} ( {p}_{i} - 1000 )}{{N}_{ap}^{SRS}} ) mod {n}_{SRS}^{cs , max} & otherwise\end{matrix}$$

where n_{SRS}^{cs}ϵ{0,1, . . . , n_{SRS}^{cs,max}−1} is contained in the higher layer parameter transmissionComb. The maximum number of cyclic shifts n_{SRS}^{cs,max} are given by Table 6.4.1.4.2-1 of [6].

TABLE 6.4.1.4.2-1
Maximum number of cyclic shifts n_{SRS}^{cs, max} as a function of K_{TC}.

| K_{TC} | n_{SRS}^{cs, max} |
|---|---|
| 2 | 8 |
| 4 | 12 |
| 8 | 6 |

When SRS is transmitted on a given SRS resource, the sequence r^{(p}^{ᵢ}⁾(n,l′) for each OFDM symbol l′ and for each of the antenna ports of the SRS resource shall be multiplied with the amplitude scaling factor β_{SRS} in order to conform to the transmit power specified in [8] and mapped in sequence starting with r^{(p}^{ᵢ}⁾(0,l′) to resource elements (k, l) in a slot for each of the antenna ports pᵢ according to:

$${a}_{{K}_{TC} {k}^{′} + {k}_{0}^{{P}_{i}} , {l}^{′} + {l}_{0}}^{( {P}_{i} )} = \{ \text{} \begin{matrix}\begin{matrix}\frac{1}{\sqrt{{N}_{ap}}} \\ {β}_{SRS} {r}^{( {p}_{i} )} ( {k}^{′} , {l}^{′} )\end{matrix} & {k}^{′} = 0 , 1 , … , {M}_{sc , b}^{SRS} - 1 & {l}^{′} = 0 , 1 , … , {N}_{symb}^{SRS} - 1 \\ 0 & otherwise & \end{matrix} .$$

The length of the sounding reference signal sequence is given by:

M_{sc,b}^{SRS}=m_{SRS,b}N_{sc}^{RB}/(K_{TC}P_{F})

where m_{SRS,b} is given by a selected row of Table 6.4.1.4.3-1 of [6] with b=B_{SRS} where B_{SRS} ϵ{0,1,2,3} is given by the field b-SRS contained in the higher-layer parameter freqHopping if configured, otherwise B_{SRS}=0. The row of the table is selected according to the index C_{SRS} ϵ{0,1, . . . ,63} given by the field c-SRS contained in the higher-layer parameter freqHopping. The quantity P_{F}ϵ{2, 4} is given by the higher-layer parameter FreqScalingFactor if configured, otherwise P_{F}=1. When FreqScalingFactor is configured, the UE expects the length of the SRS sequence to be a multiple of 6.

The frequency-domain starting position k₀^{(p}^{ᵢ}⁾ is defined by:

k₀^{(p}^{ᵢ}⁾=k₀^{(p}^{ᵢ}⁾+n_{offset}^{FH}+n_{offset}^{RPFS}

where:

$${\overline{k}}_{0}^{( {p}_{i} )} = {n}_{shift} {N}_{ss}^{RB} + ( {k}_{TC}^{( {p}_{i} )} + {k}_{0 ffset}^{{l}^{′}} ) mod {K}_{TC}$$

$${k}_{TC}^{( {p}_{i} )} = \\ \text{} \{ \begin{matrix}( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs , max} \\ ( {\overline{k}}_{TC} + {K}_{TC} / 2 ) mod {K}_{TC} & if {N}_{ap}^{SRS} = 4 , {p}_{i} ∈ \{ 1001 , 1003 \} , and {n}_{SRS}^{cs} ∈ \{ {n}_{SRS}^{cs , max} / 2 , … , {n}_{SRS}^{cs , max} - 1 \} \\ {\overline{k}}_{TC} & otherwise\end{matrix}$$

$${n}_{offset}^{FH} = {\sum }_{b = 0}^{{B}_{SRS}} {m}_{SRS , b} {N}_{sc}^{RB} {n}_{b}$$

$${n}_{offset}^{RPFS} = {N}_{sc}^{RB} {m}_{SRS , {B}_{SRS}} ( ( {k}_{F} + {k}_{hop} ) mod {P}_{F} ) / {P}_{F}$$

and
k_{F}ϵ{0,1, . . . , P_{F}−1} is given by the higher-layer parameter StartRBIndex if configured, otherwise k_{F}=0;
kₕₒₚ is given by Table 6.4.1.4.3-3 of [6] with

$${\overline{k}}_{hop} = ⌊ \frac{{n}_{SRS}}{{Π}_{{b}^{′} = {b}_{hop}}^{{B}_{SRS}} {N}_{{b}^{′}}} ⌋ mod {P}_{F}$$

$${N}_{{b}_{hop}} = 1$$

if the higher-layer parameter EnableStartRBHopping is configured, otherwise kₕₒₚ=0.

If N_{BWP}^{start}≤n_{shift} shift the reference point for k₀^{(p}^{ᵢ}⁾=0 is subcarrier 0 in common resource block 0, otherwise the reference point is the lowest subcarrier of the BWP. If the SRS is configured by the IE SRS-PosResource, the quantity k_{offset}^{l′} is given by Table 6.4.1.4.3-2 of [6], otherwise k_{offset}^{l′}=0.

The frequency domain shift value n_{shift} adjusts the SRS allocation with respect to the reference point grid and is contained in the higher-layer parameter fregDomainShift in the SRS-Resource IE or the SRS-PosResource IE. The transmission comb offset k̅_{TC} ϵ{0,1, . . . , K_{TC}−1} is contained in the higher-layer parameter transmissionComb in the SRS-Resource IE or the SRS-PosResource IE and n_{b} is a frequency position index.

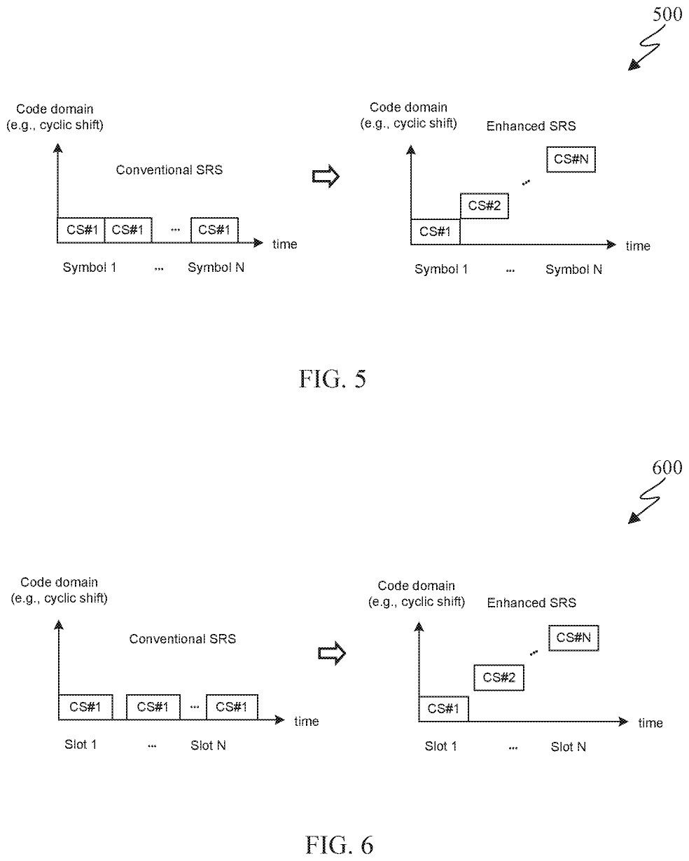

FIG. 5 illustrates an example of code-domain hopping using cyclic shift across time symbols 500 according to embodiments of the present disclosure. The embodiment of the code-domain hopping using cyclic shift across time symbols 500 illustrated in FIG. 5 is for illustration only. FIG. 5 does not limit the scope of this disclosure to any particular implementation of the code-domain hopping using cyclic shift across time symbols 500.

FIG. 6 illustrates an example of code-domain hopping using cyclic shift across time slots 600 according to embodiments of the present disclosure. The embodiment of the code-domain hopping using cyclic shift across time slots 600 illustrated in FIG. 6 is for illustration only. FIG. 6 does not limit the scope of this disclosure to any particular implementation of the code-domain hopping using cyclic shift across time slots 600.

As illustrated in FIGS. 5 and 6, in one embodiment, an SRS resource is generated based on code-domain hopping across time symbols/slots (or subframe/frame), where the code-domain hopping across time includes that code-domain parameters of the SRS resource can be differently assigned/allocated across time. For example, the code-domain parameters can include cyclic shift (CS) value/index N_{SRS}^{cs}, group or sequence index u, v. An example illustrating code-domain hopping using cyclic shift across time symbols is shown in FIG. 5. An example illustrating code-domain hopping using cyclic shift across time slots is shown in FIG. 6.

In one embodiment, the cyclic-shift index n_{SRS}^{cs} depends on a higher-layer parameter, e.g., ‘cyclicShiftHopping’ in the SRS-Resource IE or the SRS-PosResource IE.

In one example, the cyclic-shift index n_{SRS}^{cs} is determined by a function using the pseudo-random sequence c(i) defined by clause 5.2.1 of [6]. For example, n_{SRS}^{cs}=(n̅_{SRS}^{CS}+n_{SRS}^{CS,hop})mod n_{SRS}^{cs,max}, where:
n̅_{SRS}^{CS}ϵ{0,1, . . . , n_{SRS}^{cs,max}−1} is contained in the higher-layer parameter transmissionComb,
n_{SRS}^{CS,hop} is a function using pseudo-random sequence c(i), and
n_{SRS}^{cs,max} is the maximum number of cyclic shifts given by Table 6.4.1.4.2-1 of [6].

Here, in one example, n_{SRS}^{CS,hop} is a new parameter to enable cyclic-shift hopping. n_{SRS}^{CS,hop} can be as a function of time index, and thus the resultant value of n_{SRS}^{cs} can be different in time index.

In one example, cyclic shift hopping can be disabled or enabled by the higher-layer parameter ‘cyclicShiftHopping’. In one example, it can be one-bit indicator, e.g., indicating ‘on’, or ‘off’.

In one example, ‘cyclicShiftHopping’ indicates ‘off’, n_{SRS}^{CS,hop}=0. Otherwise, n_{SRS}^{CS,hop} can be a function of time index that follows one of the following examples.

In one example, n_{SRS}^{CS,hop} is a function of time index, using the pseudo-random sequence c(i).
In one example, n_{SRS}^{CS,hop}=f_{ch}(n_{s,f}^{μ}), where n_{s,f}^{μ} is a slot number within a frame for subcarrier spacing configuration μ.
   In one example, f_{ch}(n_{s,f}^{μ})=c(a·n_{s,f}^{μ}+b)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(n_{s,f}^{μ})=(Σₘ₌₀^{M-1}c(M(a·n_{s,f}^{μ}+b)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{CS,hop}=f_{ch}(n_{s,f}^{μ}, l′), where n_{s,f}^{μ} is a slot number within a frame for subcarrier spacing configuration μ, and the quantity l′ϵ{0,1, . . . , N_{symb}^{SRS}−1} is the OFDM symbol number within the SRS resource.
   In one example, f_{ch}(n_{s,f}^{μ},l′)=c(a·n_{s,f}^{μ}+b+l′)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(n_{s,f}^{μ})=(Σₘ₌₀^{M-1}c(M(a·n_{s,f}^{μ}+b+l′)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{cs,hop}=f_{ch}(nₛ^{μ}), where nₛ^{μ} is a slot number within a subframe for subcarrier spacing configuration μ.
   In one example, f_{ch}(n_{s,}^{μ})=c(a·nₛ^{μ}+b)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(nₛ^{μ})=(Σₘ₌₀^{M-1}c(a·nₛ^{μ}+b)+m)·2′^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{CS,hop}=f_{ch}(nₛ^{μ}, l′), where nₛ^{μ} is a slot number within a subframe for subcarrier spacing configuration μ, and the quantity l′ϵ{0,1, . . . , N_{symb}^{SRS}−1} is the OFDM symbol number within the SRS resource.
   In one example, f_{ch}(nₛ^{μ},l′)=c(a·nₛ^{μ}+b+l′)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(nₛ^{μ})=(Σₘ₌₀^{M-1}c(M(a·nₛ^{μ}+b+l′)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .

In one example, n_{SRS}^{CS,hop} is a function of time index and the SRS sequence n_{ID}^{SRS}, using the pseudo-random sequence c(i).
In one example, n_{SRS}^{CS,hop}=(f_{ch}(n_{s,f}^{μ})+n_{ID}^{SRS})mod n_{SRS}^{CS,max}, where n_{s,f}^{μ} is a slot number within a frame for subcarrier spacing configuration μ.
   In one example, f_{ch}(n_{s,f}^{μ})=c(a·n_{s,f}^{μ}+b)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(n_{s,f}^{μ})=(Σₘ₌₁^{M-1}c(M(a·n_{s,f}^{μ}+b)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{CS,hop}=(f_{ch}(n_{s,f}^{μ},l′)+n_{ID}^{SRS})mod n_{SRS}^{cs,max}, where n_{s,f}^{μ} is a slot number within a frame for subcarrier spacing configuration μ, and the quantity l′ϵ{0,1, . . . , N_{symb}^{SRS}−1} is the OFDM symbol number within the SRS resource.
   In one example, f_{ch}(n_{s,f}^{μ}, l′)=c(a·n_{s,f}^{μ}+b+l′)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(n_{s,f}^{μ})=(Σₘ₌₀^{M-1}c(M(a·n_{s,f}^{μ}+b+l′)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{CS,hop}=(f_{ch}(nₛ^{μ})+n_{ID}^{SRS})mod n_{SRS}^{cs,max}, where nₛ^{μ} is a slot number within a subframe for subcarrier spacing configuration μ.
   In one example, f_{ch}(nₛ^{μ})=c(a·nₛ^{μ}+b)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(nₛ^{μ})=(Σₘ₌₀^{M-1}c(M(a·nₛ^{μ}+b)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .
In one example, n_{SRS}^{CS,hop}=(f_{ch}(nₛ^{μ},l′)+n_{ID}^{SRS})mod n_{SRS}^{cs,max}, where nₛ^{μ} is a slot number within a subframe for subcarrier spacing configuration μ, and the quantity l′ϵ{0,1, . . . , N_{symb}^{SRS}−1} is the OFDM symbol number within the SRS resource.
   In one example, f_{ch}(nₛ^{μ}, l′)=c(a·nₛ^{μ}+b+l′)mod n_{SRS}^{cs,max}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{ch}(nₛ^{μ})=(Σₘ₌₀^{M-1}c(M(a·nₛ^{μ}+b+l′)+m)·2^{m})mod n_{SRS}^{cs,max}. In one example, a=1. In another example, a=N_{symb}^{slot}. In one example, b=l₀. In one example, M can be a positive integer i.e., M=1,2,3,4,5,6,7,8,9, or . . . .

In one embodiment, the cyclic-shift index n_{SRS}^{cs} depends on higher-layer parameter, e.g., ‘cyclicShiftInterval’ in the SRS-Resource IE or the SRS-PosResource IE.

In one example, the cyclic shift index n_{SRS}^{cs} is defined as n_{SRS}^{cs}=(n̅_{SRS}^{CS}+n_{SRS}^{CS,hop})mod n_{SRS}^{cs,max}, and n_{SRS}^{,CS,hop} is a function of cyclic shift interval.
For example, n_{SRS}^{CS,hop}=x·l′ where x is a value configured by ‘cyclicShiftInterval’, and the quantity l′ϵ{0,1, . . . , N_{symb}^{SRS}−1} is the OFDM symbol number within the SRS resource.
   In one example, xϵ{0,1, . . . , n_{SRS}^{cs,max}−1}.
   In another example, xϵ{1,2, . . . , n_{SRS}^{cs,max}−1}.
For example, n_{SRS}^{CS,hop}=x·l′+n_{ID}^{SRS} where x is a value configured by ‘cyclicShiftInterval’, the quantity l′ϵ{0,1, . . . , N_{symb}^{cs,max}−1} is the OFDM symbol number within the SRS resource, and n_{ID}^{SRS} is the SRS sequence ID.
   In one example, xϵ{0,1, . . . , n_{SRS}^{cs,max}−1}.
   In another example, xϵ{1,2, . . . , n_{SRS}^{cs,max}−1}.

In one example, the value of x (‘cyclicShiftInterval’ in higher-layer signaling) can be indicated via MAC-CE or DCI.
In one example, an indicator with ┌log₂ n_{SRS}^{cs,max}┐ bits is used to indicate the value of xϵ{0,1, . . . , n_{SRS}^{cs,max}−1} via MAC-CE or DCI.
In one example, an indicator with ┌log₂(n_{SRS}^{cs,max}−1)┐ bits is used to indicate the value of xϵ{1,1, . . . , n_{SRS}^{cs,max}−1} via MAC-CE or DCI.
In one example, a subset S of {0,1, . . . , n_{SRS}^{cs,max}−1} is configured via higher-layer signaling or MAC-CE, and one of the subset, i.e., xϵS is indicated via an indicator with ┌log₂|S|┐ bits.
In one example, a subset S of {1,2, . . . , n_{SRS}^{cs,max}−1} is configured via higher layer signaling or MAC-CE, and one of the subset, i.e., xϵS is indicated via an indicator with ┌log₂|S|┐ bits.

In one example, a repetition factor R_{cs} is configured via higher-layer parameter, MAC-CE, or DCI. For example, R_{cs}ϵ{2,4}. In another example, R_{cs}ϵ{2, . . . , N_{symb}^{SRS}}. In another example, R_{cs}ϵ{2, . . . , N_{symb}^{SRS}−1}. When R_{cs} is configured, n_{SRS}^{CS,hop} can be computed as follows:

$$In one example , {n}_{SRS}^{CS , hop} = x \cdot ⌊ \frac{{l}^{′}}{{R}_{cs}} ⌋ .$$

$$In one example , {n}_{SRS}^{CS , hop} = x \cdot ⌊ \frac{{l}^{′}}{{R}_{cs}} ⌋ + {n}_{ID}^{SRS} .$$

Note that regular hopping patterns not relying on a pseudo-random generator could be beneficial when mTRP manages SRS resources in scenarios where interference from mTRP or sTRP associated with other cells is limited. NW with mTRP can manage SRS interference for UEs associated with the NW through regular hopping patterns.

In one embodiment, the cyclic-shift index n_{SRS}^{cs} depends on higher-layer parameter, e.g., ‘cyclicShiftHoppingPattern’ in the SRS-Resource IE or the SRS-PosResource IE. A set of cyclic-shift hopping patterns can be defined. For example, all of possible combinations (P) with N_{symb}^{SRS} symbols each associated with one out of n_{SRS}^{cs,max} cyclic shifts can be considered for a set of cyclic-shift hopping patterns. In this case, the number of possible combinations can be given by

$${( {n}_{SRS}^{cs , max} )}^{{N}_{symb}^{SRS}} .$$

Several examples can be as follows:
In one example, cyclic shift indices n_{SRS}^{cs} for all OFDM symbols are configured via the higher layer parameter transmissionComb or higher-layer parameter cyclicShiftHoppingPattern, which is newly defined in the specification.
   In one example, cyclicShiftHoppingPattern or transmissionComb includes ┌N_{symb}^{SRS} log₂ n_{SRS}^{cs,max}┐ bits to indicate all of the possible combinations.
   In one example, cyclicShiftHoppingPattern or transmissionComb includes N_{symb}^{SRS}. ┌log₂ n_{SRS}^{cs,max}┐ bits to indicate all of the possible combinations.
In one example, n_{SRS}^{cs} is configured for a first OFDM symbol, (i.e., for l′=0) e.g., via higher layer parameter transmissionComb as in specified in TS38.211, and other cyclic-shift indices for the remaining OFDM symbols (i.e., for l′=1,2, . . . , N_{symb}^{SRS}−1) are configured via higher-layer parameter ‘cyclicShiftHoppingPattern’.
   In one example, cyclicShiftHoppingPattern includes ┌(N_{symb}^{SRS}−1)log₂ n_{SRS}^{cs,max}┐ bits to indicate all of the possible combinations for l′=1,2, . . . , N_{symb}^{SRS}−1.
   In one example, cyclicShiftHoppingPattern includes ┌(N_{symb}^{SRS}−1)log₂ n_{SRS}^{cs,max}┐ bits to indicate all of the possible combinations for l′=1,2, . . . , N_{symb}^{SRS}−1.

In one embodiment, a subset P_{sub} of all of possible combinations (P) with N_{symb}^{SRS} symbols each associated with one out of n_{SRS}^{cs,max} cyclic shifts can be considered for a set of cyclic-shift hopping patterns.

In one embodiment, a subset P_{sub} of all of possible combinations (P) with N_{symb}^{SRS}−1 symbols each associated with one out of n_{SRS}^{cs,max} cyclic shifts can be considered for a set of cyclic-shift hopping patterns.

In one embodiment, the cyclic-shift index n_{SRS}^{cs} is determined by any mixture of the above embodiments.

In one example, the cyclic-shift index n_{SRS}^{cs} is determined by using pseudo random generator across slots (or subframes/frames) and cyclicShiftInterval or cyclicShiftHoppingPattern across symbols within a slot. For example, n_{SRS}^{cs}=n̅_{SRS}^{CS}+n_{SRS,slot}^{cs,hop}+n_{SRS,sym}^{cs,hop})mod n_{SRS}^{cs,max}, where:
n̅_{SRS}^{cs}ϵ{0,1, . . . ,n_{SRS}^{cs,max}−1} is contained in the higher-layer parameter transmissionComb,
n_{SRS,slot}^{CS,hop} is a function using the pseudo-random sequence c(i) which outputs cyclic shifts with respect to slots,
c_{SRS,symbol}^{CS,hop} is a function of cyclic shift interval which outputs cyclic shifts with respect to symbol.
n_{SRS}^{cs,max} is the maximum number of cyclic shifts given by Table 6.4.1.4.2-1 of [6].

In one example, n_{SRS,slot}^{cs,hop} can be one of the examples shown herein which do not include l′, and n_{SRS,symbol}^{CS,hop} can be one of the examples herein.

In one example, n_{SRS,slot}^{CS,hop} can be one of the examples shown herein which do not include l′, and n_{SRSmsymbol}^{Cs,hop} can be one of the examples herein.

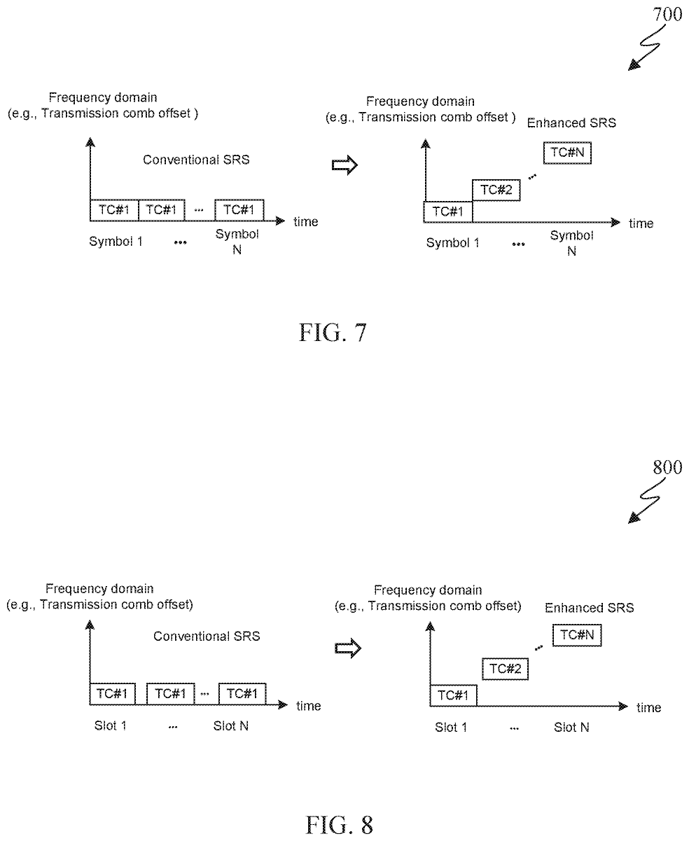

FIG. 7 illustrates an example of frequency-domain hopping using transmission comb offset across time symbols 700 according to embodiments of the present disclosure. The embodiment of the frequency-domain hopping using transmission comb offset across time symbols 700 illustrated in FIG. 7 is for illustration only. FIG. 7 does not limit the scope of this disclosure to any particular implementation of the frequency-domain hopping using transmission comb offset across time symbols 700.

FIG. 8 illustrates an example of frequency-domain hopping using transmission comb offset across time slots 800 according to embodiments of the present disclosure. The embodiment of the frequency-domain hopping using transmission comb offset across time slots 800 illustrated in FIG. 8 is for illustration only. FIG. 8 does not limit the scope of this disclosure to any particular implementation of the frequency-domain hopping using transmission comb offset across time slots 800.

As illustrated in FIGS. 7 and 8, in one embodiment, an SRS resource is generated based on frequency-domain hopping across time symbols/slots (or subframe/frame), where the frequency-domain hopping across time includes that frequency-domain parameters of the SRS resource can be differently assigned/allocated across time. For example, the frequency-domain parameters can include transmission comb offset value/index K_{TC}. An example illustrating frequency-domain hopping using transmission comb offset across time symbols is shown in FIG. 7. An example illustrating frequency-domain hopping using transmission comb offset across time slots is shown in FIG. 8.

In one embodiment, the transmission-comb offset k̅_{TC} depends on a higher-layer parameter, e.g., ‘transmissionCombOffsetHopping’ in the SRS-Resource IE or the SRS-PosResource IE.

In one example, the transmission-comb offset k̅_{TC} is determined by a function using the pseudo-random sequence c(i) defined by clause 5.2.1 of [6]. For example, k̅_{TC}=(k′_{TC}+k_{TC}^{hop})mod K_{TC}, where:
k′_{TC}ϵ{0, 1, . . . ,K_{TC}−1} is contained in the higher-layer parameter transmissionComb,
k_{TC}^{hop} is a function using the pseudo-random sequence c(i), and
K_{TC} is the higher-layer parameter transmissionComb.

Here, in one example, k_{TC}^{hop} is a new parameter to enable transmission comb offset hopping. k_{TC}^{hop} can be as a function of time index, and thus the resultant value of k_{TC}^{hop} can be different in time index.

In one example, transmission comb offset hopping can be disabled or enabled by the higher-layer parameter transmissionCombOffsetHopping. In one example, it can be one-bit indicator, e.g., indicating ‘on’, or ‘off’.

In one example, transmissionCombOffsetHopping indicates ‘off’, k_{TC}^{hop}=0. Otherwise, k_{TC}^{hop} can be a function of time index that follows one of the following examples.

In one example, k_{TC}^{hop} is a function of time index, using the pseudo-random sequence c(i).
In one example, k_{TC}^{hop}=f_{tch}(n_{s,f}^{μ}), where n_{s,f}^{μ} is a slot number within a frame for subcarrier spacing configuration μ.
   In one example, f_{tch}(n_{s,f}^{μ})=c(a·n_{s,f}^{μ}+b)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(n_{s,f}^{μ})=(Σₘ₌₀^{M-1}c(M(a·n_{s,f}^{μ}+b)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=f_{ch}(n_{s,f}^{μ},l′), where n_{s,f}^{μ} is a slot number within a frame for subcarrier spacing configuration μ, and the quantity l′ϵ{0, 1, . . . , N_{symb}^{SRS}−1} is the OFDM symbol number within the SRS resource.
   In one example, f_{tch}(n_{s,f}^{μ})=c(a·n_{s,f}^{μ}+b+l′)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(n_{s,f}^{μ})=(Σₘ₌₀^{M-1}c(M(a·n_{s,f}^{μ}+b+l′)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=f_{tch}(nₛ^{μ}), where nₛ^{μ} is a slot number within a subframe for subcarrier spacing configuration μ.
   In one example, f_{tch}(n_{s,}^{μ})=c(a·nₛ^{μ}+b)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(nₛ^{μ})=(Σₘ₌₀^{M-1}c(M(a·nₛ^{μ}+b)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=f_{tch}(nₛ^{μ},l′), where nₛ^{μ} is a slot number within a subframe for subcarrier spacing configuration μ, and the quantity l′ϵ{0,1, . . . ,N_{symb}^{SRS}−1} is the OFDM symbol number within the SRS resource.
   In one example, f_{tch}(nₛ^{μ},l′)=c(a·nₛ^{μ}+b+l′)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(nₛ^{μ})=(Σₘ₌₀^{M-1}c(M(a·nₛ^{μ}+b+l′)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .

In one example, k_{TC}^{hop} is a function of time index and the SRS sequence n_{ID}^{SRS}, using the pseudo-random sequence c(i).
In one example, k_{TC}^{hoP}=(f_{tch}(n_{s,f}^{μ})+n_{ID}^{SRS)mod K}_{TC}, where n_{s,f}^{μ} is a slot number within a frame for subcarrier spacing configuration μ.
   In one example, f_{tch}(n_{s,f}^{μ})=c(a·n_{s,f}^{μ}+b)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(n_{s,f}^{μ})=(Σₘ₌₀^{M-1}c(M(a·n_{s,f}^{μ}+b)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=(f_{tch}(n_{s,f}^{μ},l′)+n_{IS}^{SRS})mod K_{TC}, where n_{s,f}^{μ} is a slot number within a frame for subcarrier spacing configuration μ, and the quantity l′ϵ{0,1, . . . , N_{symb}^{SRS}−1} is the OFDM symbol number within the SRS resource.
   In one example, f_{tch}(n_{s,f}^{μ}, l′)=c(a·n_{s,f}^{μ}+b+l′)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(n_{s,f}^{μ})=(Σₘ₌₀^{M-1}c(M(a·n_{s,f}^{μ}+b+l′)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=(f_{tch} (nₛ^{μ})+n_{ID}^{SRS})mod K_{TC}, where nₛ^{μ} is a slot number within a subframe for subcarrier spacing configuration μ.
   In one example, f_{tch}(nₛ^{μ})=c(a·nₛ^{μ}+b)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(nₛ^{μ})=(Σₘ₌₀^{M-1}c(M(a·nₛ^{μ}+b)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .
In one example, k_{TC}^{hop}=(f_{tch}(nₛ^{μ},l′)+n_{ID}^{SRS})mod K_{TC}, where nₛ^{μ} is a slot number within a subframe for subcarrier spacing configuration μ, and the quantity l′ϵ{0,1, . . . , N_{symb}^{SRS}−1} is the OFDM symbol number within the SRS resource.
   In one example, f_{tch}(nₛ^{μ},l′)=c(a·nₛ^{μ}+b+l′)mod K_{TC}. For example, a=1. In another example, a=N_{symb}^{slot}, where N_{symb}^{slot} is a number of symbols per slot. In one example, b=l₀, where l₀ is the starting position described in clause 6.4.1.4.1 of [6].
   In one example, f_{tch}(nₛ^{μ})=(Σₘ₌₀^{M-1}c(M(a·nₛ^{μ}+b+l′)+m)·2^{m})mod K_{TC}. In one example, a=1. In another example, a=N_{symb}^{slot}. In one example, b=l₀. In one example, M can be a positive integer i.e., M=1, 2, 3, 4, 5, 6, 7, 8, 9, or . . . .

In one embodiment, the transmission comb offset k̅_{TC} depends on higher-layer parameter, e.g., transmissionCombOffsetInterval in the SRS-Resource IE or the SRS-PosResource IE.

In one example, the transmission comb offset k̅_{TC} is defined as k̅_{TC}=(k′_{TC}+k_{TC}^{hop})mod K_{TC}, and k_{TC}^{hop} is a function of transmission comb shift interval.
For example, k_{TC}^{hop}=x·l′ where x is a value configured by transmissionCombOffsetInterval, and the quantity l′ϵ{0,1, . . . , N_{symb}^{SRS}−1} is the OFDM symbol number within the SRS resource.
   In one example, xϵ{0,1, . . . , K_{TC}−1}.
   In another example, xϵ{1,2, . . . , K_{TC}−1}.
For example, k_{TC}^{hop}=x·l′+n_{ID}^{SRS} where x is a value configured by transmissionCombOffsetInterval, the quantity 1′ϵ{0,1, . . . , N_{symb}^{SRS}−1} is the OFDM symbol number within the SRS resource, and n_{ID}^{SRS} is the SRS sequence ID.
   In one example, xϵ{0,1, . . . , K_{TC}−1}.
   In another example, xϵ{1,2, . . . , K_{TC}−1}.

In one example, the value of x (transmissionCombOffsetInterval in higher-layer signaling) can be indicated via MAC-CE or DCI.
In one example, an indicator with ┌log₂ K_{TC}┐ bits is used to indicate the value of xϵ{0,1, . . . , K_{TC}−1} via MAC-CE or DCI.
In one example, an indicator with ┌log₂(K_{TC}−1)┐ bits is used to indicate the value of xϵ{1,1, . . . , K_{TC}−1} via MAC-CE or DCI.
In one example, a subset S of {0,1, . . . , K_{TC}−1} is configured via higher-layer signaling or MAC-CE, and one of the subset, i.e., xϵS is indicated via an indicator with ┌log₂|S|┐ bits.
In one example, a subset S of {1,2, . . . , K_{TC}−1} is configured via higher-layer signaling or MAC-CE, and one of the subset, i.e., xϵS is indicated via an indicator with ┌log₂|S|┐ bits.

In one example, a repetition factor R_{tcs} is configured via higher-layer parameter, MAC-CE, or DCI. For example, R_{tcs} ϵ{2,4}. In another example, R_{tcs} ϵ{2, . . . ,N_{symb}^{SRS}}. In another example, R_{tcs} ϵ{2, . . . ,N_{symb}^{SRS}−1}. When R_{tcs} is configured, k_{TC}^{hop} can be computed as follows:

$$In one example , {k}_{TC}^{hop} = x \cdot ⌊ \frac{{l}^{′}}{{R}_{cs}} ⌋ .$$

$$In one example , {k}_{TC}^{hop} = x \cdot ⌊ \frac{{l}^{′}}{{R}_{cs}} ⌋ + {n}_{ID}^{SRS} .$$

Note that regular hopping patterns not relying on a pseudo-random generator could be beneficial when mTRP manages SRS resources in scenarios where interference from mTRP or sTRP associated with other cells is limited. NW with mTRP can manage SRS interference for UEs associated with the NW through regular hopping patterns.

In one embodiment, the transmission comb offset k̅_{TC} depends on higher-layer parameter, e.g., ‘transmissionCombOffsetHoppingPattern’ in the SRS-Resource IE or the SRS-PosResource IE. A set of transmission comb offset hopping patterns can be defined. For example, all of possible combinations (P) with N_{symb}^{SRS} symbols each associated with one out of K_{TC} cyclic shifts can be considered for a set of transmission comb offset hopping patterns. In this case, the number of possible combinations can be given by (K_{TC})^{N}^{_{symb}}^{^{SRS}}. Several examples can be as follows:
In one example, transmission comb offsets k̅_{TC} for all OFDM symbols are configured via the higher layer parameter transmissionComb or higher-layer parameter ‘transmissionCombOffsetHoppingPattern’, which is newly defined in the specification.
   In one example, ‘transmissionCombOffsetHoppingPattern’ or transmissionComb includes ┌N_{symb}^{SRS} log₂ K_{TC}┐ bits to indicate all of the possible combinations.
   In one example, ‘transmissionCombOffsetHoppingPattern’ or transmissionComb includes N_{symb}^{SRS}·┌log₂ K_{TC}┐ bits to indicate all of the possible combinations.
In one example, k̅_{TC} is configured for a first OFDM symbol, (i.e., for l′=0) e.g., via higher layer parameter transmissionComb as in specified in TS38.211, and other transmission comb offsets for the remaining OFDM symbols (i.e., for l′=1, 2, . . . , N_{sysb}^{SRS}−1) are configured via higher-layer parameter ‘transmissionCombOffsetHoppingPattern’.
   In one example, ‘transmissionCombOffsetHoppingPattern’ includes ┌(N_{symb}^{SRS}−1)log₂ K_{TC}┐ bits to indicate all of the possible combinations for l′=1,2 . . . , N_{symb}^{slot}−1.
   In one example, ‘transmissionCombOffsetHoppingPattern’ includes ┌N_{symb}^{SRS}−1)log₂ K_{TC}┐ bits to indicate all of the possible combinations for l′=1,2, . . . , N_{symb}^{SRS}−1.

In one embodiment, a subset P_{sub} of all of possible combinations (P) with N_{symb}^{SRS} symbols each associated with one out of K_{TC} transmission comb offsets can be considered for a set of transmission comb offset hopping patterns.

In one embodiment, a subset P_{sub} of all of possible combinations (P) with N_{symb}^{SRS}−1 symbols each associated with one out of K_{TC} transmission comb offsets can be considered for a set of transmission comb offset hopping patterns.

In one embodiment, the transmission comb offset k̅_{TC} depends on higher-layer parameter, e.g., fregHopping in the SRS-Resource IE or the SRS-PosResource IE.

In one example, the transmission comb offset k̅_{TC} is defined as k̅_{TC}=k′_{TC}+k_{TC}^{hop})mod K_{TC}, and k_{TC}^{hop} is a function of k̅_{TC}^{hop}, and k̅_{TC}^{hop} is defined as

$${\overline{k}}_{TC}^{hop} = ⌊ \frac{{n}_{SRS}}{{\prod }_{{b}^{′} = {b}_{hop}}^{{B}_{SRS}} {N}_{{b}^{′}}} ⌋ mod {K}_{TC}$$

$${N}_{{b}_{hop}} = 1$$

In one example, the quantity k_{TC}^{hop} as a function of k̅_{TC}^{hop} follows the table.

TABLE 1

| | k_{TC}^{hop} | | |
|---|---|---|---|
| k̅_{TC}^{hop} | K_{TC} = 2 | K_{TC} = 4 | K_{TC} = 8 |
| 0 | 0 | 0 | 0 |
| 1 | 1 | 1 | 1 |
| 2 | — | 2 | 2 |
| 3 | — | 3 | 3 |
| 4 | — | — | 4 |
| 5 | — | — | 5 |
| 6 | — | — | 6 |
| 7 | — | — | 7 |

In one example, the quantity k_{TC}^{hop} as a function of k̅_{TC}^{hop} follows the table which has a different order of numbers in 2^{nd}, 3^{rd} and/or 4^{th} columns of Table 1. For example, the following table can be used:

TABLE 2

| | k_{TC}^{hop} | | |
|---|---|---|---|
| k̅_{TC}^{hop} | K_{TC} = 2 | K_{TC} = 4 | K_{TC} = 8 |
| 0 | 0 | 0 | 0 |
| 1 | 1 | 3 | 4 |
| 2 | — | 1 | 3 |
| 3 | — | 2 | 7 |
| 4 | — | — | 5 |
| 5 | — | — | 2 |
| 6 | — | — | 1 |
| 7 | — | — | 6 |

In one embodiment, the transmission comb offset k̅_{TC} is determined by any mixture of the above embodiments.

In one example, the transmission comb offset k̅_{TC} is determined by using pseudo random generator across slots (or subframes/frames) and transmissionCombOffsetInterval or ‘transmissionCombOffsetHoppingPattern’ across symbols within a slot. For example, k̅_{TC}=(k′_{TC}+k_{TC,slot}^{hop}+k_{TC,symbol}^{hop})mod K_{TC}, where:
k′_{TC}ϵ{0,1, . . . , K_{TC}−1} is contained in the higher-layer parameter transmissionComb,
k_{TC,slot}^{hop} is a function using the pseudo-random sequence c(i) which outputs transmission comb offsets with respect to slots,
k_{TC,symbol}^{hop} is a function of cyclic shift interval which outputs transmission comb offsets with respect to symbol.
K_{TC} is the transmission comb configured by higher-layer parameter transmissionComb.

In one example, k_{TC,slot}^{hop} can be one of the examples shown herein which do not include l′, and k_{TC,symbol}^{hop} can be one of the examples herein.

In one example, k_{TC,slot}^{hop} can be one of the examples shown herein which do not include l′, and k_{TC,symbol}^{hop} can be one of the examples herein.

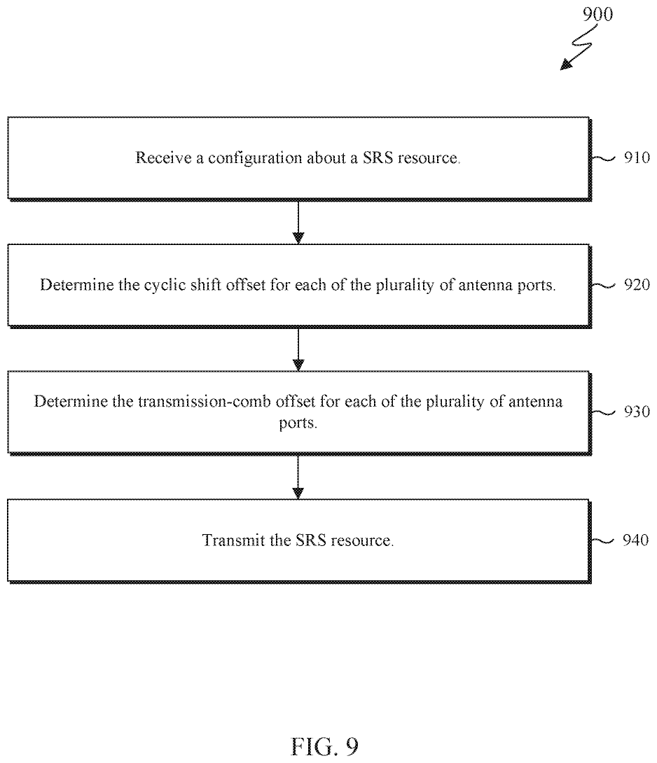

FIG. 9 illustrates an example method 900 performed by a UE in a wireless communication system according to embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method begins with the UE receiving a configuration about a SRS resource (910). For example, in 910, the configuration includes information about a cyclic shift offsetϵ{0,1, . . . , n_{SRS}^{CS,max}−1} and a transmission-comb offset ϵ{0,1, . . . , K_{TC}−1}, where n_{SRS}^{CS,max} is a maximum number of cyclic shifts and K_{TC} is a transmission comb number. The SRS resource may be associated with a plurality of antenna ports.

The UE then determines the cyclic shift offset for each of the plurality of antenna ports (920). For example, in 920, the UE determines the cyclic shift offset for each of the plurality of antenna ports based on a first pseudo-random sequence. In various embodiments, the determined cyclic shift offsetϵ{0,1, . . . , n_{SRS}^{CS,max}−1}. In various embodiments, the UE may determine the cyclic shift offset based on parameters n_{s,f}^{μ} and l′, where n_{s,f}^{μ} is a slot number within a frame for a subcarrier spacing configuration μ, and l′ϵ{0,1, . . . ,N_{symb}^{SRS}−1} is an orthogonal frequency-division multiplexing (OFDM) symbol number within the SRS resource. In various embodiments, the UE may determine the cyclic shift offset using c(a·n_{s,f}^{μ}+b+l′)mod n_{SRS}^{CS,max}, where a≥0, and b≥0 are constant values.

The UE then determines the transmission-comb offset for each of the plurality of antenna ports (930). For example, in 930, the determination of the transmission-comb offset for each of the plurality of antenna ports is based on a second pseudo-random sequence. In various embodiments, the first pseudo-random sequence and the second pseudo-random sequence correspond to c(i), where c(i) is defined by: c(i)=(x₁(n+N_{C})+x₂(n+N_{C}))mod 2, x₁(n+31)=(x₁(n+3)+x₁(n))mod 2, and x₂ (n+31)=(x₂(n+3)+x₂ (n+2)+x₂(n+1)+x₂(n))mod 2. Here, N_{C}=1600 and x₁(n) is initialized with x₁(0)=1, x₁(n)=0, n=1, 2, . . . ,30, and x₂(n) is denoted by cᵢₙᵢₜ=Σᵢ₌₀³⁰x₂(i)·2ⁱ. In various embodiments, the determined transmission-comb offsetϵ{0,1, . . . , K_{TC}−1}. In various embodiments, the UE may determine the transmission-comb offset based on parameters n_{s,f}^{μ} and l′, where n_{s,f}^{μ} is a slot number within a frame for a subcarrier spacing configuration μ and l′ϵ{0,1, . . . , N_{symb}^{SRS}−1} is an OFDM symbol number within the SRS resource. In various embodiments, the UE may determine the transmission-comb offset using c(a·n_{s,f}^{μ}+b+l′)mod K_{TC} where a≥0, and b≥0 are constant values.

The UE then transmits the SRS resource (940). For example, in 940, the SRS resource is transmitted based on the cyclic shift offset and the transmission-comb offset.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive a configuration about a sounding reference signal (SRS) resource, the configuration including information about a cyclic shift offsetϵ{0,1, . . . , n_{SRS}^{CS,max}−1} and a transmission-comb offsetϵ{0,1, . . . , K_{TC}−1}, where n_{SRS}^{CS,max} is a maximum number of cyclic shifts and K_{TC} is a transmission comb number, wherein the SRS resource is associated with a plurality of antenna ports; and
a processor operably coupled to the transceiver, the processor configured to:
determine, based on a first pseudo-random sequence, the cyclic shift offset for each of the plurality of antenna ports, and
determine, based on a second pseudo-random sequence, the transmission-comb offset for each of the plurality of antenna ports,
wherein the transceiver is further configured to transmit, based on the cyclic shift offset and the transmission-comb offset, the SRS resource.

2. The UE of claim 1, wherein the first pseudo-random sequence and the second pseudo-random sequence correspond to c(i), where c(i) is defined by:
c(i)=(x₁(n+N_{C})+x₂(n+N_{C}))mod 2,
x₁(n+31)=(x₁(n+3)+x₁(n))mod 2, and
x₂(n+31)=(x₂(n+3)+x₂(n+2)+x₂(n+1)+x₂(n))mod 2,
where N_{C}=1600 and x₁(n) is initialized with x₁(0)=1, x₁(n)=0, n=1, 2, . . . ,30, and x₂(n) is denoted by cᵢₙₜᵢ=Σᵢ₌₀³⁰x₂(i)·2ⁱ.

3. The UE of claim 1, wherein the processor is further configured to determine the cyclic shift offset within a subset of {0,1, . . . , n_{SRS}^{CS,max}−1}.

4. The UE of claim 1, wherein the processor is further configured to determine the cyclic shift offset based on parameters n_{s,f}^{μ} and l′, where n_{s,f}^{μ} is a slot number within a frame for a subcarrier spacing configuration μ, and l′ϵ{0,1, . . . ,N_{symb}^{SRS}−1} is an orthogonal frequency-division multiplexing (OFDM) symbol number within the SRS resource.

5. The UE of claim 4, wherein the processor is further configured to determine the cyclic shift offset using c(a·n_{s,f}^{μ}+b+l′)mod n_{SRS}^{cs,max}, where a≥0, and b≥0 are constant values.

6. The UE of claim 1, wherein the processor is further configured to determine the transmission-comb offset within a subset of {0,1, . . . , K_{TC}−1}.

7. The UE of claim 1, wherein the processor is further configured to determine the transmission-comb offset based on parameters n_{s,f}^{μ} and l′,
where:
n_{s,f}^{μ} is a slot number within a frame for a subcarrier spacing configuration μ, and
l′ϵ{0,1, . . . , N_{symb}^{SRS}−1} is an orthogonal frequency-division multiplexing (OFDM) symbol number within the SRS resource.

8. The UE of claim 7, wherein the processor is further configured to determine the transmission-comb offset using c(a·n_{s,f}^{μ}+b+l′)mod K_{TC} where a≥0, and b≥0 are constant values.

9. A base station (BS) comprising:
a transceiver configured to:
transmit a configuration about a sounding reference signal (SRS) resource, the configuration including information about a cyclic shift offsetϵ{0,1, . . . , n_{SRS}^{CS,max}−1} and a transmission-comb offsetϵ{0,1, . . . , K_{TC}−1}, where n_{SRS}^{CS,max} is a maximum number of cyclic shifts and K_{TC} is a transmission comb number, wherein the SRS resource is associated with a plurality of antenna ports; and
receive the SRS resource,
wherein a first pseudo-random sequence indicates the cyclic shift offset for each of the plurality of antenna ports, and
wherein a second pseudo-random sequence indicates the transmission-comb offset for each of the plurality of antenna ports.

10. The BS of claim 9, wherein the first pseudo-random sequence and the second pseudo-random sequence correspond to c(i), where c(i) is defined by:
c(i)=(x₁(n+N_{C})+x₂(n+N_{C}))mod 2,
x₁(n+31)=(x₁(n+3)+x₁(n))mod 2, and
x₂(n+31)=(x₂(n+3)+x₂(n+2)+x₂(n+1)+x₂(n))mod 2,
where N_{C}=1600 and x₁(n) is initialized with x₁(0)=1, x₁(n)=0, n=1, 2, . . . ,30, and x₂(n) is denoted by cᵢₙₜᵢ=Σᵢ₌₀³⁰x₂(i)·2ⁱ.

11. The BS of claim 9, wherein the cyclic shift offset is within a subset of {0,1, . . . , n_{SRS}^{CS,max}−1}.

12. The BS of claim 9, wherein the cyclic shift offset is based on parameters n_{s,f}^{μ} and l′, where n_{s,f}^{μ} is a slot number within a frame for a subcarrier spacing configuration μ, and l′ϵ{0,1, . . . , N_{symb}^{SRS}−1} is an orthogonal frequency-division multiplexing (OFDM) symbol number within the SRS resource.

13. The BS of claim 12, wherein the cyclic shift offset is based on c(a·n_{s,f}^{μ}+b+l′)mod n_{SRS}^{sc,max}, where a≥0, and b≥0 are constant values.

14. The BS of claim 9, wherein the transmission-comb offset is within a subset of {0,1, . . . , K_{TC}−1}.

15. The BS of claim 9, wherein the transmission-comb offset is based on parameters n_{s,f}^{μ} and l′,
where:
n_{s,f}^{μ} is a slot number within a frame for a subcarrier spacing configuration μ, and
l′ϵ{0,1, . . . , N_{symb}^{SRS}−1} is an orthogonal frequency-division multiplexing (OFDM) symbol number within the SRS resource.

16. The BS of claim 15, wherein the transmission-comb offset is based on c(a·n_{s,f}^{μ}+b+l′)mod K_{TC} where a≥0, and b≥0 are constant values.

17. A method performed by a user equipment (UE), the method comprising:
receiving a configuration about a sounding reference signal (SRS) resource, the configuration including information about a cyclic shift offsetϵ{0,1, . . . , n_{SRS}^{CS,max}−1} and a transmission-comb offsetϵ{0,1, . . . , K_{TC}−1}, where n_{SRS}^{CS,max} is a maximum number of cyclic shifts and K_{TC} is a transmission comb number, wherein the SRS resource is associated with a plurality of antenna ports;
determining, based on a first pseudo-random sequence, the cyclic shift offset for each of the plurality of antenna ports;
determining, based on a second pseudo-random sequence, the transmission-comb offset for each of the plurality of antenna ports; and
transmitting, based on the cyclic shift offset and the transmission-comb offset, the SRS resource.

18. The method of claim 17, wherein the first pseudo-random sequence and the second pseudo-random sequence correspond to c(i), where c(i) is defined by:
c(i)=(x₁(n+N_{C})+x₂(n+N_{C}))mod 2,
x₁(n+31)=(x₁(n+3)+x₁(n))mod 2, and
x₂(n+31)=(x₂(n+3)+x₂(n+2)+x₂(n+1)+x₂(n))mod 2,
where N_{C}=1600 and x₁(n) is initialized with x₁(0)=1, x₁(n)=0, n=1, 2, . . . ,30, and x₂(n) is denoted by cᵢₙₜᵢ=Σᵢ₌₀³⁰x₂(i)·2ⁱ.

19. The method of claim 17, wherein determining the cyclic shift offset further comprises determining the cyclic shift offset within a subset of {0,1, . . . , n_{SRS}^{CS,max}−1}.

20. The method of claim 17, wherein determining the cyclic shift offset further comprises determining the cyclic shift offset based on parameters n_{s,f}^{μ} and l′, where n_{s,f}^{μ} is a slot number within a frame for a subcarrier spacing configuration μ, and l′ϵ{0,1, . . . , N_{symb}^{SRS}−1} is an orthogonal frequency-division multiplexing (OFDM) symbol number within the SRS resource.
